(19) United States
(12) Patent Application Publication
(10) Pub. No.: US 2025/0242756 A1
(43) Pub. Date: Jul. 31, 2025

(54) AUTOMATICALLY RESETTABLE REARVIEW MIRROR CONVENIENT TO ASSEMBLE

(71) Applicant: Wenzhou Ronghui Automobile Technology Co., Ltd., Wenzhou (CN)

(72) Inventor: Zhifei MU, Wenzhou (CN)

(21) Appl. No.: 19/008,175

(22) Filed: Jan. 2, 2025

(30) Foreign Application Priority Data
Jan. 26, 2024 (CN) 202420195997X

(51) Int. Cl. B60R 1/076

(52) U.S. Cl. CPC B60R 1/076

(57) ABSTRACT

Disclosed is an automatically resettable rearview mirror convenient to assemble. The rearview mirror includes a mirror housing, a first connecting member, a second connecting member and a clamping mechanism, where a side edge of the mirror housing is connected to the first connecting member, the first connecting member and the second connecting member are vertically connected through a resetting mechanism, the resetting mechanism enables the first connecting member to perform circumferential resetting on the second connecting member so as to restore an original included angle between the mirror housing and a vehicle body, and the clamping mechanism is rotationally connected to a side surface of the second connecting member by 360°. The rearview mirror can be reset after collision through the resetting mechanism, and components of the rearview mirror are simple in structure and can be disassembled and assembled.

### CROSS-REFERENCE TO RELATED APPLICATIONS

The present application claims priority to Chinese Patent Application No. 202420195997X, filed on Jan. 26, 2024, the entire disclosure of which is incorporated herein by reference.

### TECHNICAL FIELD

The present disclosure relates to an automatically resettable rearview mirror convenient to assemble.

### BACKGROUND

A rearview mirror is a tool for a driver sitting on a seat of a cab to directly acquire external information such as a rear, a side, and a bottom of a vehicle. In order to facilitate operation by the driver, prevent occurrence of driving safety accidents and ensure personal safety, all countries stipulate that the rearview mirror must be mounted on the vehicle, and all the rearview mirrors must have a direction adjustment function. In a running process of the vehicle, collision and scraping are inevitably generated, but a traditional rearview mirror does not have an anti-collision function and is likely to be damaged in a collision or scraping process.

For the patent application document with the application No. CN202120777183.3 and titled with Locomotive Rearview Mirror, the patent includes a mirror body provided with a mirror and a base, where the mirror body and the base are connected by means of a transversely arranged rotating portion in a matching manner, such that the mirror body can rotate in an axial direction of the rotating portion; and a soft elastic object is arranged in a rotating portion in a matching manner. The rotating portion achieves limiting rotation between the mirror body and the base by means of a rotating shaft member. The soft elastic object is arranged at the rotating shaft member in a matching manner. A groove is provided in the base, the soft elastic object is arranged in the groove in a matching manner, and the rotating shaft member connected between the mirror body and the base penetrates the soft elastic object. The rearview mirror can be easily adjusted to a specified angle, but an automatic resetting function is lacked, and the rearview mirror is complex in structure.

### SUMMARY

Aiming at the defects in the prior art, an objective of the present disclosure is to provide an automatically resettable rearview mirror convenient to assemble. The rearview mirror can be automatically reset after collision through a resetting mechanism, and components of the rearview mirror are simple in structure and can be disassembled and assembled, such that the rearview mirror is convenient to disassemble and assemble in a maintenance process.

In order to achieve the above objective, the present disclosure provides the following technical solutions: an automatically resettable rearview mirror convenient to assemble includes a mirror housing, a first connecting member, a second connecting member and a clamping mechanism, where the first connecting member and the second connecting member are vertically connected through a resetting mechanism, the resetting mechanism enables the first connecting member to perform circumferential resetting on the second connecting member so as to restore an original included angle between the mirror housing and a vehicle body, and the clamping mechanism is rotationally connected to a side surface of the second connecting member by 360°.

Preferably, the second connecting member includes a connecting housing, the connecting housing is vertically provided with a through hole, a side wall of the through hole extends outwards to form a limiting step, and a lower end surface of the limiting step is uneven.

Preferably, a lower splicing block extends transversely from a lower end of the side wall of the connecting housing, and the lower splicing block is provided with a lower arc groove. An upper end surface of the lower splicing block is detachably connected to an upper splicing block, the upper splicing block is provided with an upper arc groove, and the upper arc groove and the lower arc groove are spliced to form a spherical groove in an enclosed manner.

Preferably, the end surface, facing the spherical groove, of the clamping mechanism is provided with a sphere, the spherical groove is rotationally arranged on the sphere in a sleeving manner, and the spherical groove is capable of rotating freely by 360° along the sphere.

Preferably, the sphere is provided with several concave holes.

preferably, the clamping mechanism includes a first mounting clamp provided with the sphere and a second mounting clamp, and the first mounting clamp and the second mounting clamp are adjustably connected. The first mounting clamp and the second mounting clamp are oppositely provided with clamping portions, and anti-skid pads are mounted on opposite inner side edges of the clamping portions.

Preferably, the first mounting clamp is provided with a U-shaped groove, the U-shaped groove is provided with a threaded groove with the same length, and the second mounting clamp is provided with a U-shaped block corresponding to the U-shaped groove. A side wall of the U-shaped block is in threaded connection to a second threaded rod, and the U-shaped block is inserted into the U-shaped groove and is in threaded connection to the threaded groove through the second threaded rod.

Preferably, the first connecting member includes an inverted L-shaped connecting plate, a bulge extends downwards from a short end surface of the connecting plate and faces towards the end surface of the connecting housing, a rod body inserted into the through hole is arranged downwards in a middle of the bulge, and a plurality of sector grooves are circumferentially provided at a lower end surface of the rod body. The bulge, the rod body and the connecting plate are provided with penetrating holes at the same axis, and the resetting mechanism penetrates the penetrating holes and the through hole to connect the inverted L-shaped connecting plate and the connecting housing.

Preferably, the resetting mechanism includes a first threaded rod, a convex block, a compensation block, an expansion spring and a nut which is in threaded connection to an end portion of the first threaded rod, and an upper end surface of the convex block abuts against the lower end surface of the limiting step through the first threaded rod and the expansion spring. Sector blocks abutting against one side surfaces of the sector grooves are circumferentially distributed on an inner wall of a convex block hole, gaps between the sector blocks and the sector grooves are compensated by the compensation blocks, and the compensation block is vertically and slidably connected to an interior of the convex block hole. When the mirror housing collides, the rod body rotates, the convex block is misplaced, and the compensation block moves downwards, such that the expansion spring is compressed downwards. After the mirror housing collides, the expansion spring generates a resetting force and is reset with the mirror housing.

Preferably, the resetting mechanism further includes a first washer, a second washer, an elastic washer, a fourth washer and an abutting sheet, where the first washer is arranged between the head of the first threaded rod and an upper end surface of the connecting plate, the second washer is arranged between the bulge and an upper end surface of the connecting housing, the elastic washer and the fourth washer abut against a lower end surface of the compensation block, and the abutting sheet is arranged between the expansion spring and the nut.

### Beneficial Effects

1. The first connecting member and the second connecting member are connected through the arrangement of the resetting mechanism, and the first connecting member rotates circumferentially on the second connecting member to reset. When the mirror housing collides, the convex block and the lower end surface of the limiting step are misaligned, and the compensation block moves downwards to drive the expansion spring to be pressed down. After the collision, the expansion spring is reset, and the convex block and the compensation block rotate with the rod body to restore the original included angle between the mirror housing and the vehicle body.

2. The second connecting member is rotationally connected to the clamping mechanism through the spherical groove by 360° to obtain more different viewing angles. The clamping mechanism includes the first mounting clamp and the second mounting clamp, the first mounting clamp and the second mounting clamp are oppositely provided with the clamping portions, and sizes of the clamping portions are adjusted through the second threaded rod, such that A-pillars of different vehicle models with different thicknesses are mounted, and the practicability of the rearview mirror is realized.

3. In the present disclosure, the mirror housing, the first connecting member, the second connecting member, the resetting mechanism and the clamping mechanism can be disassembled and assembled, such that the rearview mirror can be disassembled and installed conveniently in a maintenance process, and a single component can be replaced without integral disassembly when the component is damaged, which is conductive to reduction of the maintenance cost of an owner.

### BRIEF DESCRIPTION OF THE DRAWINGS

FIG. 1 is a perspective schematic diagram of a rearview mirror.

FIG. 2 is a cutaway view of a resetting mechanism.

FIG. 3 is an exploded schematic diagram of a rearview mirror.

FIG. 4 is an exploded schematic diagram of a clamping mechanism and a connecting housing.

FIG. 5 is a schematic diagram of a connecting housing and a connecting plate.

FIG. 6 is a schematic diagram of a convex block.

Reference numerals in figures: 1. mirror housing; 2. first connecting member; 21. connecting plate; 22. bulge; 23. rod body; 231. sector groove; 232. penetrating hole; 3. second connecting member; 31. connecting housing; 32. through hole; 321. limiting step; 33. lower splicing block; 34. upper splicing block; 35. upper arc groove; 36. lower arc groove; 4. clamping mechanism; 41. sphere; 411. concave hole; 42. first mounting clamp; 43. second mounting clamp; 44. clamping portion; 45. anti-skid pad; 5. resetting mechanism; 50. first threaded rod; 51. convex block; 511. convex block hole; 512, sector block; 52. compensation block; 53. expansion spring; 54. nut; 55. first washer; 56. second washer; 57. elastic washer; 58. fourth washer; 59. abutting sheet; 6. U-shaped groove; 7, threaded groove; 8. U-shaped block; and 9. second threaded rod.

### DETAILED DESCRIPTIONS OF THE EMBODIMENTS

The present disclosure is further described below in combination with the drawings and the preferred examples.

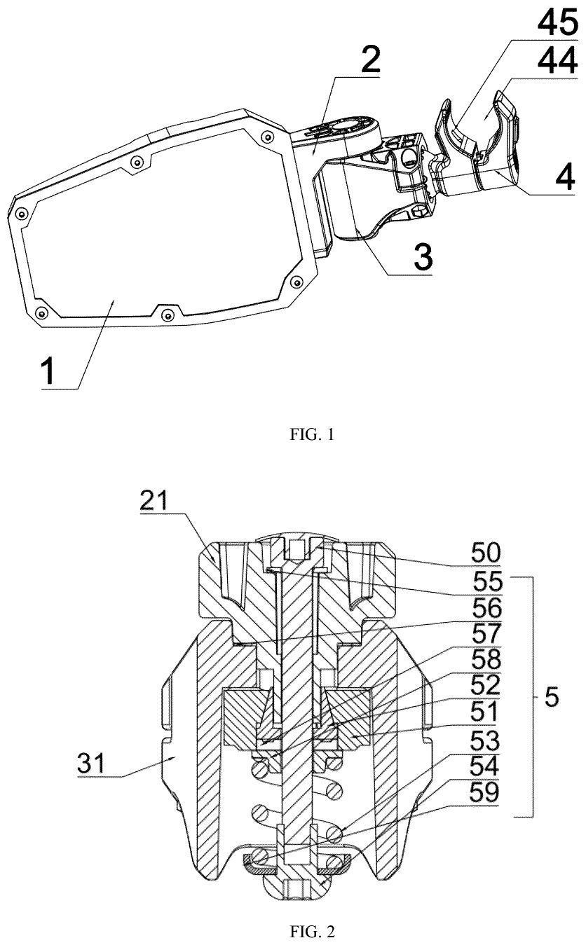

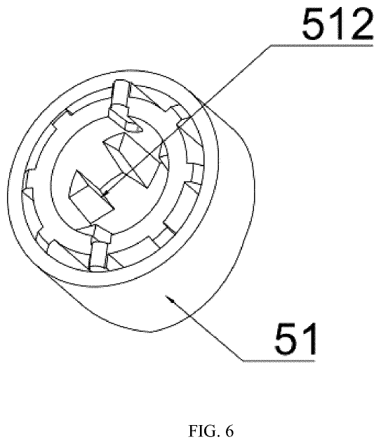

Referring to FIGS. 1-6, an automatically resettable rearview mirror convenient to assemble of the present disclosure includes a mirror housing 1, a first connecting member 2, a second connecting member 3 and a clamping mechanism 4, where the mirror housing 1 includes a rear cover and a front cover, a mirror surface is arranged between the rear cover and the front cover, and the front cover and the rear cover are in threaded connection through screws. A side edge of the mirror housing 1 is detachably connected to the first connecting member 2 or is internally formed. In the present disclosure, the detachable connection is preferably selected, such that one of the mirror housing or the first connecting member can be replaced independently when the mirror housing 1 or the first connecting member 2 is damaged later. The first connecting member 2 and the second connecting member 3 are vertically connected through a resetting mechanism 5. When the mirror housing 1 collides, the mirror housing 1 rotates circumferentially on the second connecting member with the first connecting member 2, and after the mirror housing 1 collides, the resetting mechanism 5 drives the first connecting member to perform circumferential resetting on the second connecting member 3 so as to restore an original included angle between the mirror housing 1 and a vehicle body, and the clamping mechanism 4 is rotationally connected to a side surface of the second connecting member 3 by 360°, such that the viewing angle of the rearview mirror is adjusted, and a more appropriate viewing angle is obtained.

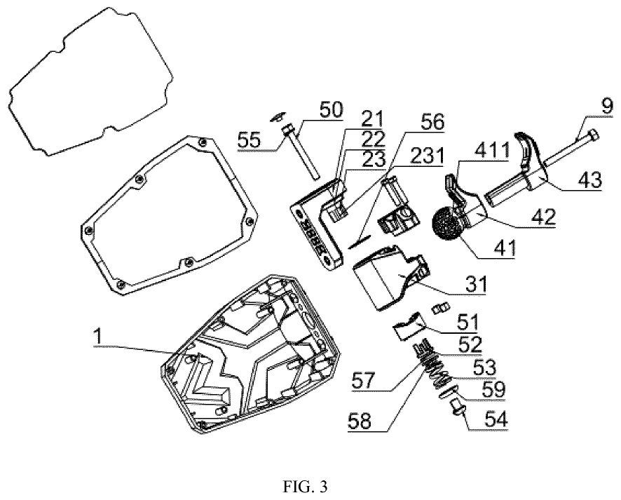

Referring to FIGS. 3, 5 and 6, the second connecting member 3 includes a connecting housing 31, the connecting housing 31 is vertically provided with a through hole 32, and a side wall of the through hole 32 extends outwards to form a limiting step 321. The limiting step 321 is in communication with an upper portion and a lower portion of the connecting housing 31, and the limiting step 321 is arranged close to an upper end of the connecting housing 31. A lower end surface of the limiting step 321 is uneven, that is, concave surfaces and convex surfaces are arranged, and any one concave surface is adjacent to one convex surface. The first connecting member 2 includes an inverted L-shaped connecting plate 21, a bulge 22 extends downwards from a short end surface of the connecting plate 21 and faces towards the end surface of the connecting housing 31, a rod body 23 inserted into the through hole 32 is arranged downwards in a middle of the bulge 22, and a plurality of sector grooves 231 are circumferentially provided at a lower end surface of the rod body 23. The bulge 22, the rod body 23 and the connecting plate 21 are provided with penetrating holes 232 at the same axis, a step surface is arranged at an upper end of the penetrating hole 232 of the connecting plate 21, and the resetting mechanism 5 penetrates the penetrating holes 232 and the through hole 32 to connect the connecting plate 21 and the connecting housing 31. An upper end of the resetting mechanism 5 abuts against the step surface, and the penetrating hole 232 of the connecting plate 21 is provided with a cover.

The resetting mechanism 5 includes a first threaded rod 50, a convex block 51, a compensation block 52, an expansion spring 53 and a nut 54 which is in threaded connection to an end portion of the first threaded rod 50, and an upper end surface of the convex block 51 is uneven and matches the lower end surface of the limiting step 321. After the head of the first threaded rod 50 abuts against the step surface, the first threaded rod 50 penetrates the penetrating holes 232, the through hole 32, the convex block 51, the compensation block 52 and the expansion spring 53, and then is in threaded connection to the nut 54. The convex block 51, the compensation block 52 and the expansion spring 53 are limited to the lower portion of the connecting housing 31 through the threaded connection between the first threaded rod 50 and the nut 54 and the arrangement of the limiting step 321, and the upper end surface of the convex block 51 abuts against the lower end surface of the limiting step 321. A convex block hole is provided in a middle of the convex block 51, sector blocks 512 abutting against one side surfaces of the sector grooves 231 are circumferentially distributed in an interior of the convex block hole, and the compensation block 52 is vertically and slidably connected to the interior of the convex block hole. A plurality of polygonal blocks extend from the compensation block 52, and the polygonal blocks are spliced with the sector blocks 512 and match the sector grooves 231. Gaps between the sector blocks 512 and the sector grooves 231 are compensated through the arrangement of the compensation block 52, such that jitter between the first connecting member 2 and the second connecting member 3 is prevented. When the mirror housing 1 collides, the rod body 23 rotates and drives the upper end surface of the convex block 51 to be misaligned with the lower end surface of the limiting step 321, and the compensation block 52 moves downwards, such that the expansion spring 53 is compressed downwards. After the collision, the expansion spring 53 is reset and drives the compensation block 52 and the convex block 51 to move forwards to generate a resetting force, such that the rod body 23 is reset to an original set position with the mirror housing 1.

Referring to FIG. 3, in order to strengthen the close fit between the resetting mechanism and the connecting plate 21 and the connecting housing 31 and ensure the resetting effect of the resetting mechanism itself, the resetting mechanism further includes a first washer 55, a second washer 56, an elastic washer 57, a fourth washer 58 and an abutting sheet 59. The first washer 55 is arranged between the head of the first threaded rod 50 and an upper end surface of the connecting plate 21, the second washer 56 is arranged between the bulge 22 and the upper end surface of the connecting housing 31, and the elastic washer 57 and the fourth washer 58 abut against the lower end surface of the compensation block 52, such that the position of the compensation block 52 in the convex block 51 is stabilized. The elastic washer 57 is a washer with elasticity, and is preferably made of a rubber material. In order to ensure that the polygonal blocks on the compensation block 52 can always be attached to the sector grooves 231 and the sector blocks 512 so as to realize gap compensation, referring to FIG. 2 as an example, if the elastic washer 57 is not provided to provide an upward elastic jacking force for the compensation block 52, in the case of collision of the mirror housing, when the sector grooves 231 are rotated with the sector blocks 512 to be misaligned, it is likely to cause the compensation block 52 to move downwards and further cause the compensation block 52 to lose a gap compensation function. Therefore, due to the arrangement of the elastic washer 57, the elastic washer 57 itself has elasticity and is preferably made of the rubber material. When the compensation block 52 moves downwards, the elastic washer 57 will prevent the compensation block 52 from moving downwards, thereby continuously ensuring that the compensation block 52 always provides gap compensation for the sector grooves 231 and the sector blocks 512.

The fourth washer 58 further abuts against the upper end surface of the expansion spring 53, and the abutting sheet 59 abuts against the lower end surface of the expansion spring 53, thereby further ensuring that expansion of the expansion spring 53 directly acts on the compensation block 52 and the convex block 51.

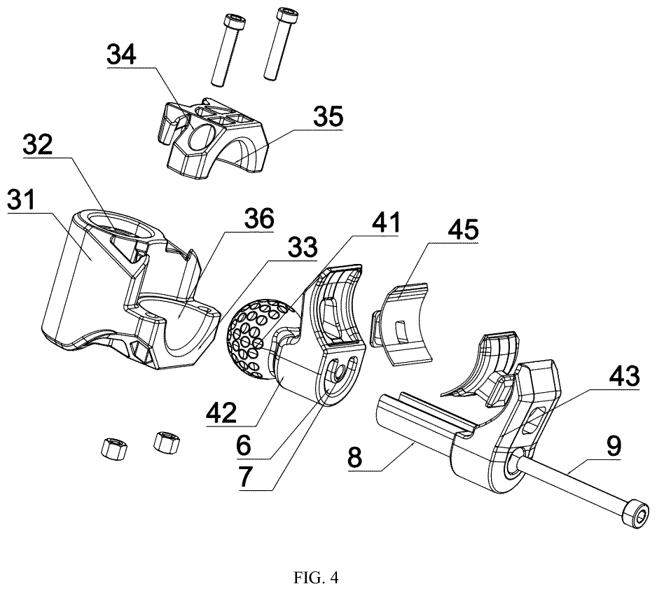

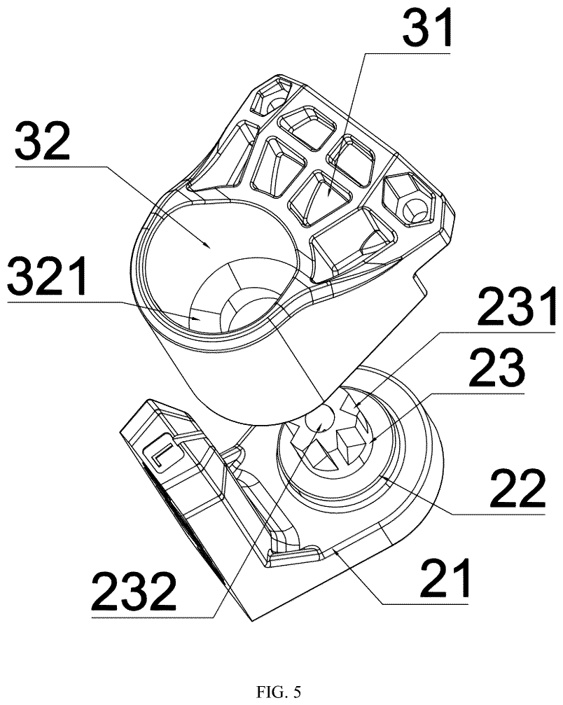

Referring to FIG. 4, a lower splicing block 33 extends transversely from a lower end of the side wall of the connecting housing 31, and the lower splicing block 33 is provided with a lower arc groove 36. An upper end surface of the lower splicing block 33 is detachably connected to an upper splicing block 34, and the upper splicing block 34 and the lower splicing block 33 are preferably connected through a screw rod and the nut 54. The upper splicing block 34 is provided with an upper arc groove 35, and the upper arc groove 35 and the lower arc groove 36 are spliced to form a spherical groove in an enclosed manner. The end surface, facing the spherical groove, of the clamping mechanism 4 is provided with a sphere 41, the spherical groove is rotationally arranged on the sphere 41 in a sleeving manner, and the spherical groove rotates by 360° along the sphere 41. In order to strengthen resistance between the sphere 41 and the spherical groove and avoid loosening of the connecting housing 31 and the clamping mechanism 4, the sphere 41 is provided with several concave holes 411 so as to further increase the resistance. The clamping mechanism 4 includes a first mounting clamp 42 provided with the sphere 41 and a second mounting clamp 43, the first mounting clamp 42 and the second mounting clamp 43 are adjustably connected, and adjustment can be performed according to A-pillars of different vehicle models with different thicknesses. The first mounting clamp 42 and the second mounting clamp 43 are oppositely provided with clamping portions 44, and anti-skid pads 45 are mounted on opposite inner side edges of the clamping portions 44. The anti-skid pads 45 are preferably detachably connected to the inner side edges of the clamping portions 44, such that when an anti-skid effect decreases after a long time of use in a later period, the anti-skid pads 45 are easier to replace, and the anti-skid pads 45 and the clamping mechanism 4 are prevented from being replaced completely.

Specifically, for the adjusting method for the first mounting clamp 42 and the second mounting clamp 43, the first mounting clamp 42 is provided with a U-shaped groove 6, the U-shaped groove 6 is provided with a threaded groove 7 with the same length, and the second mounting clamp 43 is provided with a U-shaped block 8 corresponding to the U-shaped groove 6. A side wall of the U-shaped block 8 is in threaded connection to a second threaded rod 9, and the U-shaped block 8 is inserted into the U-shaped groove 6 and is in threaded connection to the threaded groove 7 through the second threaded rod 9. When the clamping portions 44 need to be enlarged, sizes of the clamping portions 44 can be changed by rotating the threaded rod to adjust the threaded position of the threaded rod in the threaded groove 7 and further adjust the position of the U-shaped block 8 in the U-shaped groove 6.

What is claimed is:

1. An automatically resettable rearview mirror convenient to assemble, comprising a mirror housing, a first connecting member, a second connecting member and a clamping mechanism, wherein a side edge of the mirror housing is connected to the first connecting member, the first connecting member and the second connecting member are vertically connected through a resetting mechanism, the resetting mechanism enables the first connecting member to perform circumferential resetting on the second connecting member so as to restore an original included angle between the mirror housing and a vehicle body, and the clamping mechanism is rotationally connected to a side surface of the second connecting member by 360°.

2. The automatically resettable rearview mirror convenient to assemble according to claim 1, wherein the second connecting member comprises a connecting housing, the connecting housing is vertically provided with a through hole, a side wall of the through hole extends outwards to form a limiting step, and a lower end surface of the limiting step is uneven.

3. The automatically resettable rearview mirror convenient to assemble according to claim 2, wherein a lower splicing block extends transversely from a lower end of the side wall of the connecting housing, the lower splicing block is provided with a lower arc groove, an upper end surface of the lower splicing block is detachably connected to an upper splicing block, the upper splicing block is provided with an upper arc groove, and the upper arc groove and the lower arc groove are spliced to form a spherical groove in an enclosed manner.

4. The automatically resettable rearview mirror convenient to assemble according to claim 3, wherein the end surface, facing the spherical groove, of the clamping mechanism is provided with a sphere, the spherical groove is rotationally arranged on the sphere in a sleeving manner, and the spherical groove is capable of rotating freely by 360° along the sphere.

5. The automatically resettable rearview mirror convenient to assemble according to claim 4, wherein the sphere is provided with several concave holes.

6. The automatically resettable rearview mirror convenient to assemble according to claim 5, wherein the clamping mechanism comprises a first mounting clamp provided with the sphere and a second mounting clamp, the first mounting clamp and the second mounting clamp are adjustably connected, the first mounting clamp and the second mounting clamp are oppositely provided with clamping portions, and anti-skid pads are mounted on opposite inner side edges of the clamping portions.

7. The automatically resettable rearview mirror convenient to assemble according to claim 6, wherein the first mounting clamp is provided with a U-shaped groove, the U-shaped groove is provided with a threaded groove with the same length, the second mounting clamp is provided with a U-shaped block corresponding to the U-shaped groove, a side wall of the U-shaped block is in threaded connection to a second threaded rod, and the U-shaped block is inserted into the U-shaped groove and is in threaded connection to the threaded groove through the second threaded rod.

8. The automatically resettable rearview mirror convenient to assemble according to claim 7, wherein the first connecting member comprises an inverted L-shaped connecting plate, a bulge extends downwards from a short end surface of the connecting plate and faces towards the end surface of the connecting housing, a rod body inserted into the through hole is arranged downwards in a middle of the bulge, a plurality of sector grooves are circumferentially provided at a lower end surface of the rod body, the bulge, the rod body and the connecting plate are provided with penetrating holes at the same axis, and the resetting mechanism penetrates the penetrating holes and the through hole to connect the connecting plate and the connecting housing.

9. The automatically resettable rearview mirror convenient to assemble according to claim 8, wherein the resetting mechanism comprises a first threaded rod, a convex block, a compensation block, an expansion spring and a nut which is in threaded connection to an end portion of the first threaded rod, an upper end surface of the convex block abuts against the lower end surface of the limiting step through the first threaded rod and the expansion spring, sector blocks abutting against one side surfaces of the sector grooves are circumferentially distributed on an inner wall of a convex block hole, gaps between the sector blocks and the sector grooves are compensated by the compensation block, the compensation block is vertically and slidably connected to an interior of the convex block hole, and when the mirror housing collides, the rod body rotates, the convex block is misplaced, and the compensation block moves downwards, such that the expansion spring is compressed downwards; and after the mirror housing collides, the expansion spring generates a resetting force and is reset with the mirror housing.

10. The automatically resettable rearview mirror convenient to assemble according to claim 9, wherein the resetting mechanism further comprises a first washer, a second washer, an elastic washer, a fourth washer and an abutting sheet, the first washer is arranged between the head of the first threaded rod and an upper end surface of the connecting plate, the second washer is arranged between the bulge and an upper end surface of the connecting housing, the elastic washer and the fourth washer abut against a lower end surface of the compensation block, and the abutting sheet is arranged between the expansion spring and the nut.
